(19) United States
(12) Patent Application Publication
(10) Pub. No.: US 2019/0165534 A1
(43) Pub. Date: May 30, 2019

(54) MICRO-COAXIAL WIRE BONDING

(71) Applicant: The Charles Stark Draper Laboratory, Inc., Cambridge, MA (US)

(72) Inventors: Peter Houghton Lewis, Cambridge, MA (US); Caprice Gray Haley, Cambridge, MA (US); Mitchell W. Meinhold, Cambridge, MA (US)

(21) Appl. No.: 16/201,013

(22) Filed: Nov. 27, 2018

Related U.S. Application Data
(60) Provisional application No. 62/590,806, filed on Nov. 27, 2017.

(51) Int. Cl. H01R 43/02; H01R 4/02; H01R 12/53; H01R 4/58; B23K 1/00

(52) U.S. Cl. CPC H01R 43/0235; H01R 4/023; H01R 12/53; B23K 2101/38; H01R 4/58; B23K 1/0008; H01R 43/0207

(57) ABSTRACT

A method includes attaching a micro-coaxial wire to electrical contacts in a substrate, the micro-coaxial wire including a core wire, a bonded section, and a shield layer, the electrical contacts including a first electrical contact and a second electrical contact. Attaching the micro-coaxial wire to the electrical contacts includes connecting a core wire of the micro-coaxial wire to the first electrical contact including forming a bonded section by bonding the core wire to the first electrical contact, and then depositing solder onto the bonded section of the core wire.

### CROSS-REFERENCE TO RELATED APPLICATIONS

This application claims the benefit of U.S. Provisional Application No. 62/590,806 filed Nov. 27, 2017.

### BACKGROUND

This invention relates to wiring systems.

With today's high-density interconnection technology, skilled engineers require weeks or months to design and layout a multi-layer printed circuit board. For high-volume manufacturing this non-recurring engineering (NRE) cost is amortized over thousands or more units. For prototypes and low-volume manufacturing, this NRE is a major cost contributor that cannot be amortized.

### SUMMARY

Aspects described herein combine a thermosonic bonding process with an automated soldering process to provide a secure and high conductivity bond between two independent electrical contact points on a micro-coaxial wire and two independent electrical contact points on a substrate (e.g., signal and ground contact points).

In a general aspect, a method includes attaching a micro-coaxial wire to electrical contacts in a substrate, the micro-coaxial wire including a core wire, a bonded section, and a shield layer, the electrical contacts including a first electrical contact and a second electrical contact. Attaching the micro-coaxial wire to the electrical contacts includes connecting a core wire of the micro-coaxial wire to the first electrical contact including forming a bonded section by bonding the core wire to the first electrical contact, and then depositing solder onto the bonded section of the core wire.

Aspects may include one or more of the following features.

The method may include connecting the shield layer of the micro-coaxial wire to the second electrical contact including depositing a conductive material onto the shield layer and the second electrical contact. Depositing the conductive material onto the shield layer and the second electrical contact may include solder ball jetting a solder ball onto the shield layer and the second electrical contact. Depositing the conductive material onto the shield layer and the second electrical contact may include aerosol jet printing the conductive layer onto an insulating layer deposited on the core wire. The conductive material may include a silver ink.

Bonding the core wire to the first electrical contact may include thermosonically bonding the core wire. Depositing solder onto the bonded section of the core wire may include solder ball jetting the solder onto the bonded section of the core wire. The micro-coaxial wire may have an outer diameter less than 100 μm. The micro-coaxial wire may have an outer diameter less than 50 μm. The micro-coaxial wire may have an outer diameter less than 20 μm. The micro-coaxial wire may have an impedance in a range of 2-70 Ohms.

In another general aspect, an apparatus for attaching a micro-coaxial wire to electrical contacts in a substrate, the micro-coaxial wire including a core wire, a bonded section, and a shield layer, the electrical contacts including a first electrical contact and a second electrical contact, attaching the micro-coaxial wire to the electrical contacts includes a bonding tool for connecting a core wire of the micro-coaxial wire to the first electrical contact including forming a bonded section by bonding the core wire to the first electrical contact, and a soldering tool for depositing solder onto the bonded section of the core wire.

Aspects may include one or more of the following features.

The soldering tool may be further configured to connect the shield layer of the micro-coaxial wire to the second electrical contact by depositing a conductive material onto the shield layer and the second electrical contact. The soldering tool may include a solder ball jetting tool for depositing a solder ball onto the shield layer and the second electrical contact. The apparatus may include an aerosol jetting tool configured to aerosol jet print the conductive layer onto an insulating layer deposited on the core wire. The conductive material may include a silver ink.

The bonding tool may include a thermosonic bonding tool. The soldering tool may include a solder ball jetting tool configured to solder ball jet the solder onto the bonded section of the core wire. The bonding tool and the soldering tool may be configured to use micro-coaxial with outer diameter less than 100 μm. The bonding tool and the soldering tool may be configured to use micro-coaxial with outer diameter less than 50 μm. The bonding tool and the soldering tool may be configured to use micro-coaxial with outer diameter less than 20 μm. The bonding tool and the soldering tool may be configured to use micro-coaxial wire with an impedance in a range of 2-70 Ohms.

Aspects may have one or more of the following advantages.

Among other advantages, the method for securely attaching a micro-coaxial wire results in a low resistance connection between the core wire and the first electrical contact and a low inductance, low resistance connection between the shield layer and the second electrical contact. Using a solder ball in addition to thermosoncially bonding the core wire to the first electrical contact provides a more secure connection to the first electrical contact than would be provided by thermosonic bonding alone. Connecting the shield layer to the second electrical contact using a solder ball also provides a secure bond. In particular, the solder ball at least partially surrounds a section of the micro-coaxial wire, resulting in the section of the micro-coaxial wire being securely bonded to the second electrical contact. In some examples, the method advantageously eliminates the need for applying insulation over the core wire to make a connection to the shield.

Aspects advantageously minimize impedance by minimizing a volume of the joint between the micro-coaxial wire and the connection pad in the substrate. For example, given a 10 pH/mm coaxial wire, a 1.0 mm joint has a 100 pH impedance but a 0.2 mm joint has a 17 pH impedance.

Other features and advantages of the invention are apparent from the following description, and from the claims.

### DESCRIPTION OF DRAWINGS

FIG. 1 is a micro-coaxial wire prior to attachment to connection pads in a substrate.

FIG. 2 shows the micro-coaxial wire of FIG. 1 having its conductive core wire bonded to a first connection pad.

FIG. 3 shows the micro-coaxial wire of FIG. 1 having solder deposited on the bond between the conductive core and the first connection pad.

FIG. 4 shows the micro-coaxial wire of FIG. 1 having solder deposited on its conductive shield layer and on a second connection pad to establish a bond between the conductive shield layer and the second connection pad.

### DESCRIPTION

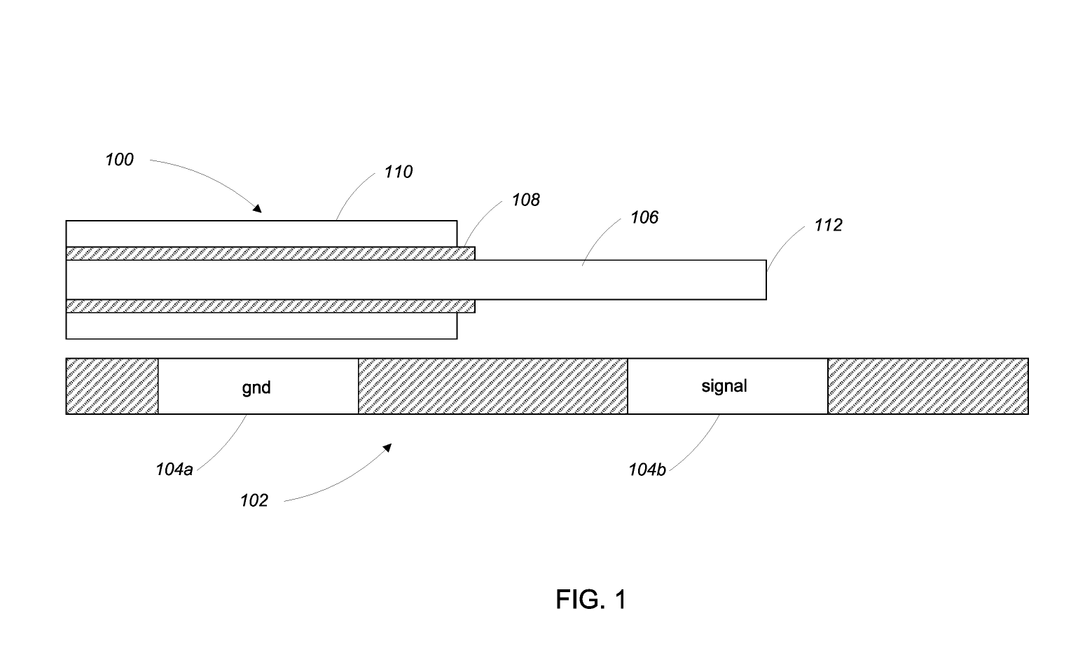

Referring to FIG. 1, a micro-coaxial wire 100 is positioned above a substrate 102 and is prepared for a low resistance, low inductance connection to connection pads 104a, 104b embedded in the substrate 102.

The micro-coaxial wire 100 includes an electrically conductive core wire 106 with an insulating layer 108 disposed thereon. An electrically conductive shield layer 110 is disposed on the insulating layer 108. In some examples, the conductive core wire 106 has a substantially cylindrical shape and the insulating layer 108 has a substantially tube-like shape with an inner diameter that conforms to an outer diameter of the conductive core wire 106. The conductive core wire 106 is therefore embedded in the insulating layer 108. The conductive shield layer 110 also has a substantially tube-like shape with an inner diameter that conforms to an outer diameter of the insulating layer 108. The insulating layer 108 is therefore embedded in the conductive shield layer 110.

The substrate 102 is formed from an insulating material (e.g., fiberglass) with the connection pads 104a, 104b embedded therein. In general, the connection pads 104a, 104b are formed from a conductive material (e.g., copper). In some examples, one or both of the connection pads 104a, 104b are part of vias that extend through or partially through the substrate 102. One or more of the connection pads 104a, 104b may also be connected to conductive traces (not shown) embedded in the substrate 102.

In the example shown in FIG. 1, a distal end 112 of the micro-coaxial wire 100 has the conductive shield layer 110 and the insulating layer 108 removed (e.g., stripped or etched), such that a part of the conductive core wire 106 is exposed. The exposed part of the conductive core wire 106 at the distal end 112 of the micro-coaxial wire 100 is positioned over a “signal” connection pad 104b, to which it will be connected. A part of the conductive shield layer 110 is positioned over a “gnd” (i.e., ground) connection pad 104a, to which it will be connected.

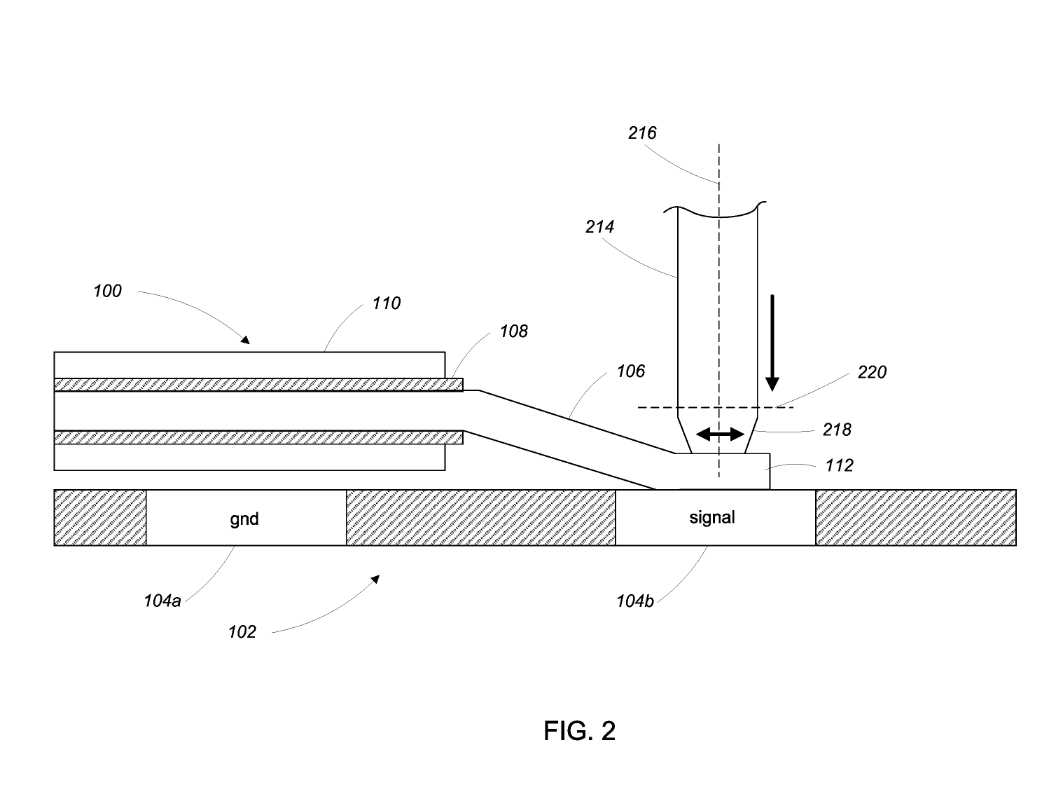

Referring to FIG. 2, with the micro-coaxial wire 100 prepared for connection to the connection pads 104a, 104b in the substrate 102, a bonding tool 214 (e.g., a thermosonic bonding tool) connects the exposed part of the conductive core wire 106 at the distal end 112 of the micro-coaxial wire 100 to the “signal” connection pad 104b. In some examples, in the case where the bonding tool 214 is a thermosonic bonding tool, some or all of the bonding tool 214, the “signal” connection pad 104b, and the exposed part of the conductive core wire 106 are heated. The bonding tool 214 applies a force along a vertical axis 216 of the bonding tool 214 to press the exposed part of the conductive core wire 106 against the “signal” connection pad 214. With the bonding tool 214 pressed against the exposed part of the conductive core wire 106, a distal end 218 of the bonding tool 214 moves back and forth (e.g., oscillates at an ultrasonic frequency) in a scrubbing motion along a horizontal axis 220.

The combination of the heated connection pad 104b and bonding tool 2014, the force applied along the vertical axis 216 of the bonding tool 214, and the scrubbing motion of the distal end 218 of the bonding tool 214 bonds the exposed part of the conductive core wire 106 to the “signal” connection pad 104b.

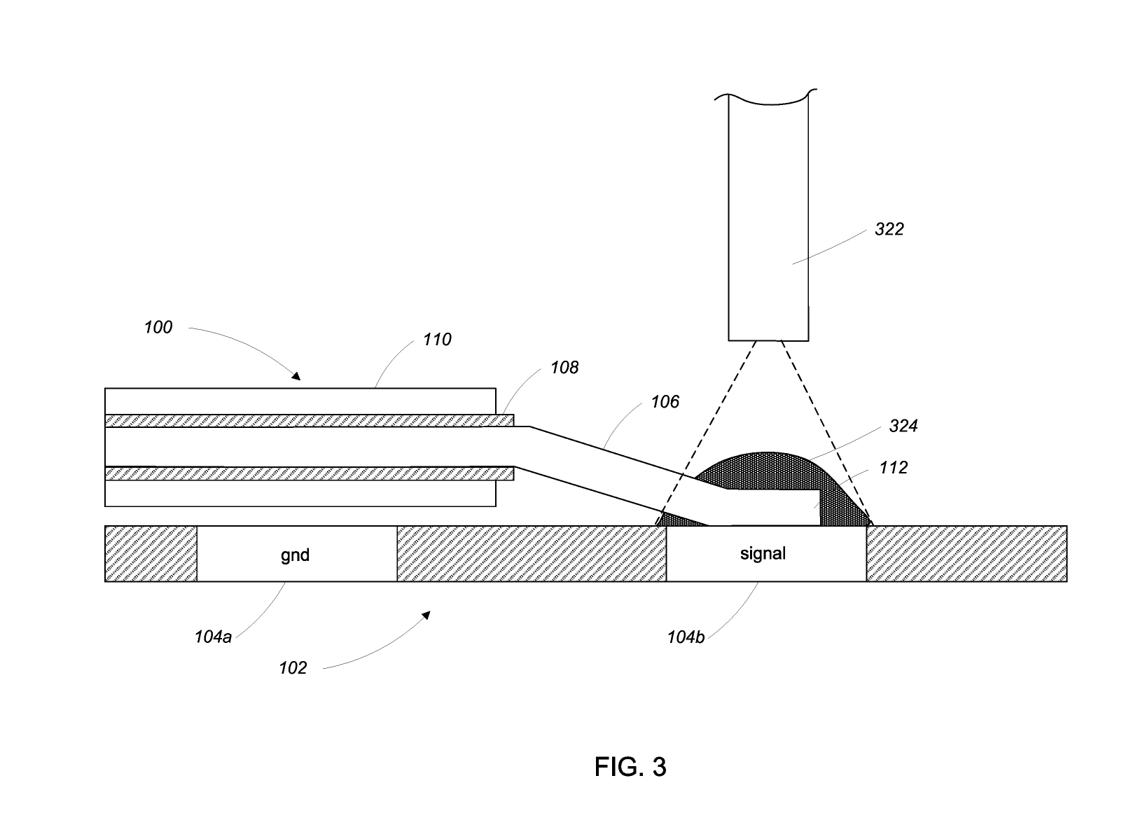

Referring to FIG. 3, with the exposed part of the conductive core wire 106 bonded to the “signal” connection pad 104b, a “security bond” is added to further secure the bond between the conductive core wire 106 and the “signal” connection pad 104b. In some examples, the security bond is established by first positioning a solder ball jetting tool 322 over the bonded conductive core wire 106 and “signal” connection pad 104b. A solder ball 324 is then deposited on the bond between the conductive core wire 106 and the “signal” connection pad 104b. The solder ball 324 is reflowed (e.g., by heating the solder ball using, for example, a laser). The reflowed solder ball 324 at least partially encompasses and secures the bond between the conductive core wire 106 and the “signal” connection pad 104b.

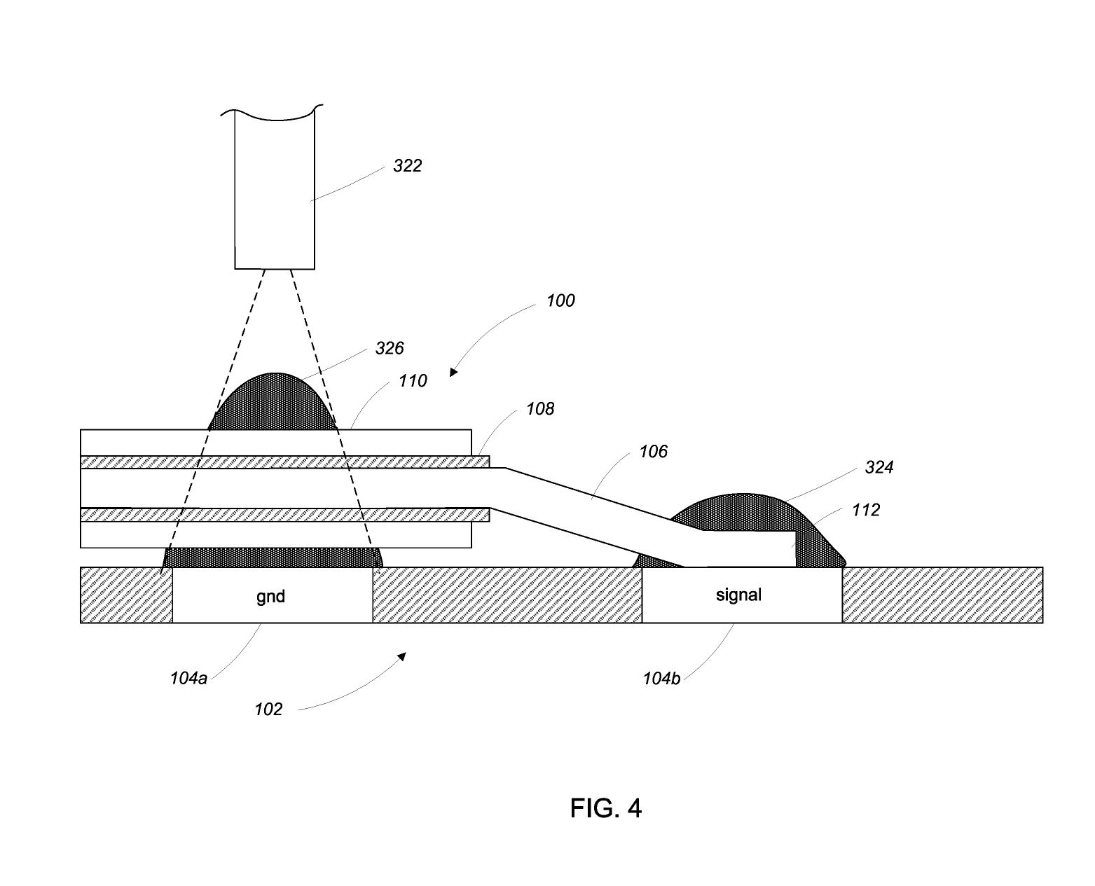

Referring to FIG. 4, to bond the conductive shield layer 110 to the “gnd” connection pad 104a, the solder ball jetting tool 322 is positioned over the “gnd” connection pad 104a and a portion of the conductive shield layer 110 that is disposed proximal to the “gnd” connection pad 104a. A solder ball 326 is deposited on the conductive shield layer 100 and the “gnd” connection pad 104a. The solder ball 326 is then reflowed (e.g., by heating the solder ball using, for example, a laser). The reflowed solder ball 326 bonds and electrically connects the conductive shield layer 110 and the “gnd” connection pad 104a.

### Alternatives

In general, the micro-coaxial wires used in the embodiments described herein have an outer diameter of less than 100 μm. In some examples, the micro-coaxial wires used in the embodiments described herein have impedance in a range of 2-70 Ohms. Other examples of micro-coaxial wires that can be used in the embodiments described above include the micro-coaxial wires described in PCT Application No.: PCT/US17/32136, which is incorporated herein by reference.

In some examples, other bonding techniques are used to attach parts of the micro-coaxial wire to connector pads in the substrate. For example, peg bonding is a low resistance methodology for attaching the conductive core wire and peg bonded connections can also be secured with solder balls. In other examples, a stud bump is added to a top of the conductive core wire as a security bond. In other examples shield connections are established using a conductive epoxy or aerosol jet printing. Other techniques use conductive overmolds to connect the shield layer to ground, but those strategies require a printed insulating material.

In some examples, when an aerosol jet printing technique is used to connect the shield layer to the second electrical contact (e.g., to ground), an insulating layer is deposited on the core wire and a conductive coating is deposited on the insulating layer, connecting the shield layer to the second electrical contact. In some examples, the conductive coating is silver (Ag) Ink that is deposited using aerosol jet printing.

In some examples, the attachment process is automatable with minor modifications to the integration tools described in U.S. patent application Ser. No. 15/592,694, titled “Wiring System,” and U.S. Patent Application No. 62/544,279, titled “Wire Handling Apparatus,” the contents of which are incorporated herein by reference.

Other techniques include using an adapter soldered to the substrate to attach micro-coaxial wires. The adapter makes mechanical contact to both the shield and the core of the micro-coaxial wire using a clamping mechanism. But some adapter-based techniques have 2-3 mm footprints that may be too large for chip-scale interconnects.

It is to be understood that the foregoing description is intended to illustrate and not to limit the scope of the invention, which is defined by the scope of the appended claims. Other embodiments are within the scope of the following claims.

What is claimed:

1. A method comprising:
attaching a micro-coaxial wire to electrical contacts in a substrate, the micro-coaxial wire including a core wire, a bonded section, and a shield layer, the electrical contacts including a first electrical contact and a second electrical contact, attaching the micro-coaxial wire to the electrical contacts comprising:
connecting a core wire of the micro-coaxial wire to the first electrical contact including forming a bonded section by bonding the core wire to the first electrical contact, and then depositing solder onto the bonded section of the core wire.

2. The method of claim 1 further comprising connecting the shield layer of the micro-coaxial wire to the second electrical contact including depositing a conductive material onto the shield layer and the second electrical contact.

3. The method of claim 2 wherein depositing the conductive material onto the shield layer and the second electrical contact includes solder ball jetting a solder ball onto the shield layer and the second electrical contact.

4. The method of claim 2 wherein depositing the conductive material onto the shield layer and the second electrical contact includes aerosol jet printing the conductive layer onto an insulating layer deposited on the core wire.

5. The method of claim 4 wherein the conductive material includes a silver ink.

6. The method of claim 1 wherein bonding the core wire to the first electrical contact includes thermosonically bonding the core wire.

7. The method of claim 1 wherein depositing solder onto the bonded section of the core wire includes solder ball jetting the solder onto the bonded section of the core wire.

8. The method of claim 1 wherein the micro-coaxial wire has an outer diameter less than 100 μm.

9. The method of claim 8 wherein the micro-coaxial wire has an outer diameter less than 50 μm.

10. The method of claim 9 wherein the micro-coaxial wire has an outer diameter less than 20 μm.

11. The method of claim 1 wherein the micro-coaxial wire has an impedance in a range of 2-70 Ohms.

12. An apparatus for attaching a micro-coaxial wire to electrical contacts in a substrate, the micro-coaxial wire including a core wire, a bonded section, and a shield layer, the electrical contacts including a first electrical contact and a second electrical contact, attaching the micro-coaxial wire to the electrical contacts, the apparatus comprising:
a bonding tool for connecting a core wire of the micro-coaxial wire to the first electrical contact including forming a bonded section by bonding the core wire to the first electrical contact, and
a soldering tool for depositing solder onto the bonded section of the core wire.

13. The apparatus of claim 12 wherein the soldering tool is further configured to connect the shield layer of the micro-coaxial wire to the second electrical contact by depositing a conductive material onto the shield layer and the second electrical contact.

14. The apparatus of claim 13 wherein the soldering tool includes a solder ball jetting tool for depositing a solder ball onto the shield layer and the second electrical contact.

15. The apparatus of claim 13 further comprising an aerosol jetting tool configured to aerosol jet print the conductive layer onto an insulating layer deposited on the core wire.

16. The apparatus of claim 15 wherein the conductive material includes a silver ink.

17. The apparatus of claim 12 wherein the bonding tool includes a thermosonic bonding tool.

18. The apparatus of claim 12 wherein the soldering tool includes a solder ball jetting tool configured to solder ball jet the solder onto the bonded section of the core wire.

19. The apparatus of claim 12 wherein the bonding tool and the soldering tool are configured to use micro-coaxial with outer diameter less than 100 μm.

20. The apparatus of claim 19 wherein the bonding tool and the soldering tool are configured to use micro-coaxial with outer diameter less than 50 μm.

21. The apparatus of claim 20 wherein the bonding tool and the soldering tool are configured to use micro-coaxial with outer diameter less than 20 μm.

22. The apparatus of claim 12 wherein the bonding tool and the soldering tool are configured to use micro-coaxial wire with an impedance in a range of 2-70 Ohms.
